(19) United States
(12) Patent Application Publication
(10) Pub. No.: US 2024/0205111 A1
(43) Pub. Date: Jun. 20, 2024

(54) CENTRALIZED PLATFORM FOR TELECOMMUNICATION SERVICES ORDERING AND PROVISIONING

(71) Applicant: RAKUTEN SYMPHONY SINGAPORE PTE. LTD., Singapore (SG)

(72) Inventors: Jun Liang LIM, Singapore (SG); Kumeresh KHANNA, Singapore (SG)

(73) Assignee: RAKUTEN SYMPHONY SINGAPORE PTE. LTD., Singapore (SG)

(21) Appl. No.: 17/802,582

(22) PCT Filed: Jun. 27, 2022
(86) PCT No.: PCT/US2022/035056

§ 371 Date: Jan. 4, 2024

(51) Int. Cl. H04L 41/5051; H04L 41/0806; H04L 41/0869; H04L 43/0811

(52) U.S. Cl. CPC H04L 41/5051; H04L 41/0806; H04L 41/0869; H04L 43/0811

(57) ABSTRACT

A method and system of ordering and provisioning telecommunications related services via a centralized platform. Here, the method and system can include receiving a first service order request from a user to purchase a telecommunications related service, allocating one or more service parameters with respect to first service order, and implementing the telecommunications related service for the user with respect to the received first service order request. The method and system can further include verifying the implementation of the telecommunications related service, tracking the allocation, implementation, or verification of the telecommunications related service, and closing the first service order request.

### BACKGROUND

The traditional market for network related services is highly fragmented. Even in the age of the Internet, a buyer of network services typically has to contact each vendor individually through email or telephone, evaluate their qualifications and negotiate specifications and products, availability and price on an individual basis, among other factors. As a result, comparison shopping, negotiation, and collaboration with service providers and vendors have traditionally been time-consuming, inefficient, and costly for the buyer of network services. Specifically, the telecommunications industry has one of the most complex and tedious processes for network operators to look for end-to-end solutions, service providers, vendors, or implementors to help solve and implement their network operational business plans. Traditionally, telecommunication systems have been mainly hardware-based, wherein hardware devices were usually proprietary or managed by a specific vendor. Therefore, a network operator needs to carefully select appropriate vendors to provide network services to fulfil the network operator's needs. Further, different regions and customers have different requirements for network services, and it can be a challenging task for the network operator to select the appropriate network service providers or vendors that can fulfil all of its customers' need. Even after having selected the vendor or service provider, various types of arrangements will need to be made by the network operator in order to deploy, implement, or onboard the service (e.g., schedule site visits, on-site installation, etc.), including testing of such services.

Further, the vendors are typically selected by the network operator, and the end user or customer of a particular service is not able to select the service provider(s) or vendor(s) he wants to work with. For instance, once an end user/customer chooses a network operator, the network services that are provided by the network operator will be bundled with the specific service provider(s) or vendors selected by the network operator, and not selected by the customer. Thus, if the customer is not satisfied with the service provider(s) or vendors, they may need to file a complaint to the network operator or may need to change to another network operator.

In addition, there is no current solution that providers a centralized platform that allows the product service order ordered and also manage and track the provisioning of such product or service, including the provisioning of resources. Hence, there is a need to provide a solution to reduce or eliminate the network operator's burden of selecting service providers and on-boarding the network services, and to further provide flexibility to the end user or customer to choose the network services (and the respective providers) as per the customer's needs or requirements, and further manage and track the provisioning of such services to the customer.

### SUMMARY

According to example embodiments, a telecommunication or networking related product or service ordering and provisioning system via a centralized network platform is disclosed that enables users to market and sell their network and telecommunication related services to customers who are looking to build solutions and run their business, including the purchasing of such services by customers, and further tracking and managing the provision of such services. In particular, the telecommunication network services can be defined and provided in software-based form or virtual network services, such as Virtualized Network Functions (VNFs) or Software Defined Networking (SDN), among others, and also as hardware-based services, such as gateway on-site, landlines, and on-premises data centers, among others. Accordingly, the software-based and virtualized network services and hardware-based services can be stored in a cloud cluster (such as a hybrid cloud, data centers, etc.) via the centralized platform according to one or more embodiments. It is contemplated within the scope of the present disclosure described herein that any other type of service or product not limited to telecommunications or network services may be used with respect to the disclosure described herein. Here, the service providers of the centralized platform can directly configure how they want to promote and sell their network services to customers. Similarly, the end users and customers can also customize the requirement of network services they wish to purchase and select the most appropriate service providers and specific vendors, as desired. In particular, the centralized platform of the disclosure described herein can include a central platform for a telecommunications related target market audience that is seeking solutions to run their business via a central hub or single telecommunications service ordering and provisioning online marketplace. By simplifying and automating the process, such as the process of capturing product interest to fulfilment and orchestration of order, and further tracking and managing customer orders and the provisioning and implementation of such services, both buyers, sellers, vendors, suppliers, and third parties of the centralized platform can save time and resources as opposed to manual interventions, thereby automating the process and minimizing errors, and improving customer satisfaction, among other advantages. And through this automation, the centralized platform of the disclosure described herein can provide a simple, flexible, cost-effective, efficient, and fast deployment of network solutions to customers.

According to example embodiments, when a customer order is received or created for a service or product via the centralized platform, the following steps can be performed: At step 1) the customer identification and data can be acquired (such as via the customer login to the central platform network. At step 2) authentication and authorization process can be performed to whether the order is feasible or not, and if it is, then creating the order (“Issue Customer Order”); here, an authorization check can be performed for the customer credit, and also determine customer order feasibility (such as whether the customer has an existing product, or whether due to customer's location or company size that the customer order can be processed) and the process may also engage an operations team (subscription list) to check on the customer feasibility. At step 3) the process can break down a customer order into a service order and resource order, and further automatically allocate and activate the product or service and closing the customer order. At step 4) the service order and resource order can be run in parallel to each other. At step 5), it can be determined whether the resource order is tangible or intangible (e.g., software). At step 6), a party order for a vendor and third party for physical product (e.g. 5G satellite) can be received, wherein a ticket can be submitted to the third party to perform an installation for the customers service order. At step 7) an invoice can be sent out to the customer with respect to the ordered and installed service.

According to example embodiments, a service order can refer to orders required to satisfy a particular customer order information received (e.g. requests for service provisioning to satisfy service problem recovery activities, alleviate service performance issues, etc.). Here, a service order orchestration layer can provide workflow and orchestration of the service order across a service order management area. The service order process can include the following steps: 1) decomposing or restructuring the customer order into related service orders; 2) issuing service orders to the service orchestrator to activate components/products/services; 3) issuing an allocation request to the resource order management if resources are required; 4) closing a service order when fulfilment activities are completed; and 5) reporting the completion to the customer order orchestrator layer.

According to example embodiments, a resource order can refer to orders that require actions to fulfil a service or customer order information (e.g. validating resource availability, delivery, installation, etc.). Here, a resource order orchestration layer can be responsible for managing and tracking the resource order, which can communicate with the service order management. The resource order process can include the following steps: 1) generating resource orders for fulfilment activities; 2) issuing resource orders to a resource orchestrator to allocate resources, and issuing an allocation request to a party order management if external party involvement are required; 3) closing resource order when fulfilment activities are completed; and 4) reporting completion of the service order to service/customer order orchestrator layer.

According to embodiments, a party order refers to orders that require external party involvement (such as a third party vendor, supplier, or installer) for any delivery, installation, acceptance testing, or commissioning required. Here, party order management is generally to ensure a party's orders are being processed and delivered efficiently and effectively, and that escalation is being invoked as required for any open party orders in jeopardy or at issue. The party order process can include the following steps: 1) obtaining party order request and generating a party order; 2) issuing a party order to external party for fulfilment activities; 3) close a party order when fulfilment activities are completed; and 4) report completion to the resource orchestrator layer.

According to example embodiments, a method of ordering and provisioning telecommunications related services via a centralized platform is disclosed, the method including: receiving a first service order request from a user to purchase a telecommunications related service; allocating one or more service parameters with respect to first service order; implementing the telecommunications related service for the user with respect to the received first service order request; verifying the implementation of the telecommunications related service; tracking the allocation, implementation, or verification of the telecommunications related service; and closing the first service order request.

In addition, wherein the step of receiving the first service order request may further include determining a viability or feasibility of the first service order request, and upon determining that first service order request is viable or feasible, creating a second service order with respect to the first service order request.

Further, the step of implementing the telecommunications related service with respect to the first service order request may further include configuring and activating the telecommunications related service.

Also, the step of verifying the implementation of the telecommunications related service may further include testing an end-to-end connectivity and performance of the telecommunications related service.

In addition, the step of allocating one or more service parameters with respect to the first service order may further include determining an availability of the one or more service parameters with respect to the first service order request.

Moreover, upon determining that the telecommunications related service is available, the method may further include reserving the one or more service parameters with respect to the telecommunications related service.

Further, the step of verifying the implementation of the telecommunications related service may further include storing the results of the verification.

Also, the method may further include initiating a first resource order with respect to the first service order request; and allocating one or more resources with respect to the first resource order.

The method may also include activating the allocated one or more resources with respect to the first resource order.

In addition, the method may include verifying the activated one or more resources with respect to first resource order.

According to example embodiments, an apparatus for ordering and provisioning telecommunications related services via a centralized platform is disclosed, including: a memory storage storing computer-executable instructions; and a processor communicatively coupled to the memory storage, wherein the processor is configured to execute the computer-executable instructions and cause the apparatus to: receive a first service order request from a user to purchase a telecommunications related service; allocate one or more service parameters with respect to first service order; implement the telecommunications related service for the user with respect to the received first service order request; verify the implementation of the telecommunications related service; track the allocation, implementation, or verification of the telecommunications related service; and close the first service order request.

Further, the computer-executable instructions, when executed by the processor, may further cause the apparatus to: wherein the step of receiving the first service order request may further cause the apparatus to determine a viability or feasibility of the first service order request, and upon determining that the first service order request is viable or feasible, create a second service order with respect to the first service order request.

In addition, the computer-executable instructions, when executed by the processor, further cause the apparatus to: wherein the step of implementing the telecommunications related service with respect to the first service order request may further cause the apparatus to configure and activate the telecommunications related service.

Also, the computer-executable instructions, when executed by the processor, may further cause the apparatus to: wherein the step of verifying the implementation of the telecommunications related service may further cause the apparatus to test an end-to-end connectivity and performance of the telecommunications related service.

Moreover, the computer-executable instructions, when executed by the processor, may further cause the apparatus to: wherein the step of allocating one or more service parameters with respect to the first service order may further cause the apparatus to determine an availability of the one or more service parameters with respect to the first service order request.

In addition, the computer-executable instructions, when executed by the processor, may further cause the apparatus to: upon determining that the telecommunications related service is available, reserve the one or more service parameters with respect to the telecommunications related service.

Also, the computer-executable instructions, when executed by the processor, may further cause the apparatus to: wherein the step of verifying the implementation of the telecommunications related service may further cause the apparatus to store the results of the verification.

Moreover, the computer-executable instructions, when executed by the processor, may further cause the apparatus to: initiate a first resource order with respect to the first service order request; and allocate one or more resources with respect to the first resource order.

Further, the computer-executable instructions, when executed by the processor, may further cause the apparatus to: activate the allocated one or more resources with respect to the first resource order.

According to example embodiments, a non-transitory computer-readable medium comprising computer-executable instructions for ordering and provisioning telecommunications related services via a centralized platform by an apparatus, wherein the computer-executable instructions, when executed by at least one processor of the apparatus, cause the apparatus to: receive a first service order request from a user to purchase a telecommunications related service; allocate one or more service parameters with respect to first service order; implement the telecommunications related service for the user with respect to the received first service order request; verify the implementation of the telecommunications related service; track the allocation, implementation, or verification of the telecommunications related service; and close the first service order request.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture according to one or more embodiments;

FIG. 2 illustrates a flowchart of a method for the centralized platform according to one or more embodiments;

FIG. 3 illustrates another flowchart of the method for the centralized platform according to one or more embodiments;

FIG. 4 illustrates another flowchart of the method for the centralized platform according to one or more embodiments;

FIG. 5 illustrates a more detailed flowchart of FIG. 3 of the method for the centralized platform according to one or more embodiments; and

FIG. 6 illustrates another flowchart of a method for the centralized platform according to one or more embodiments, which is a continuation of FIG. 5.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHIF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

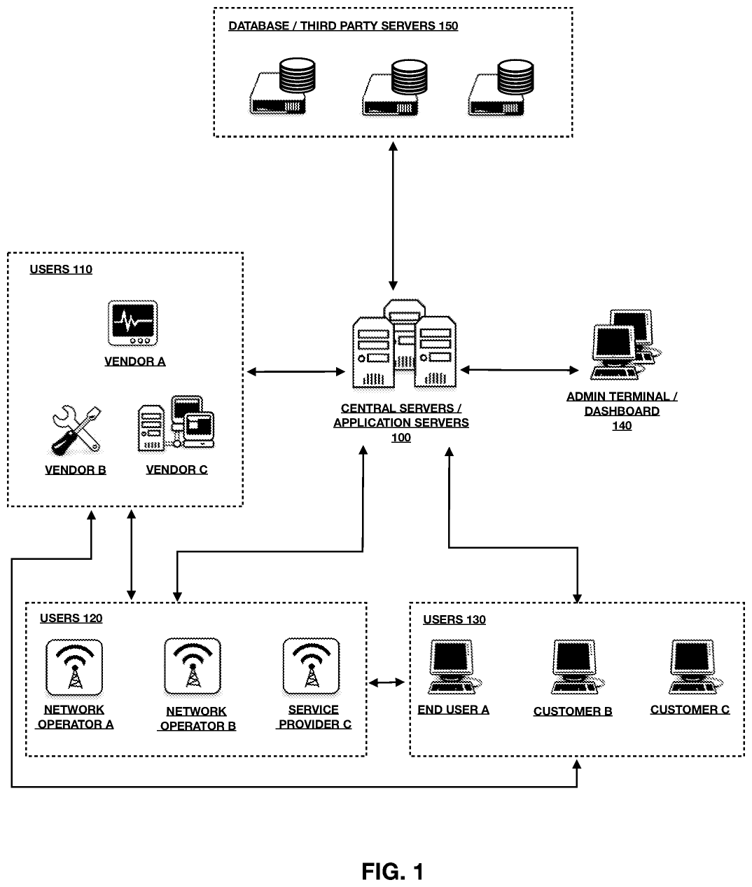

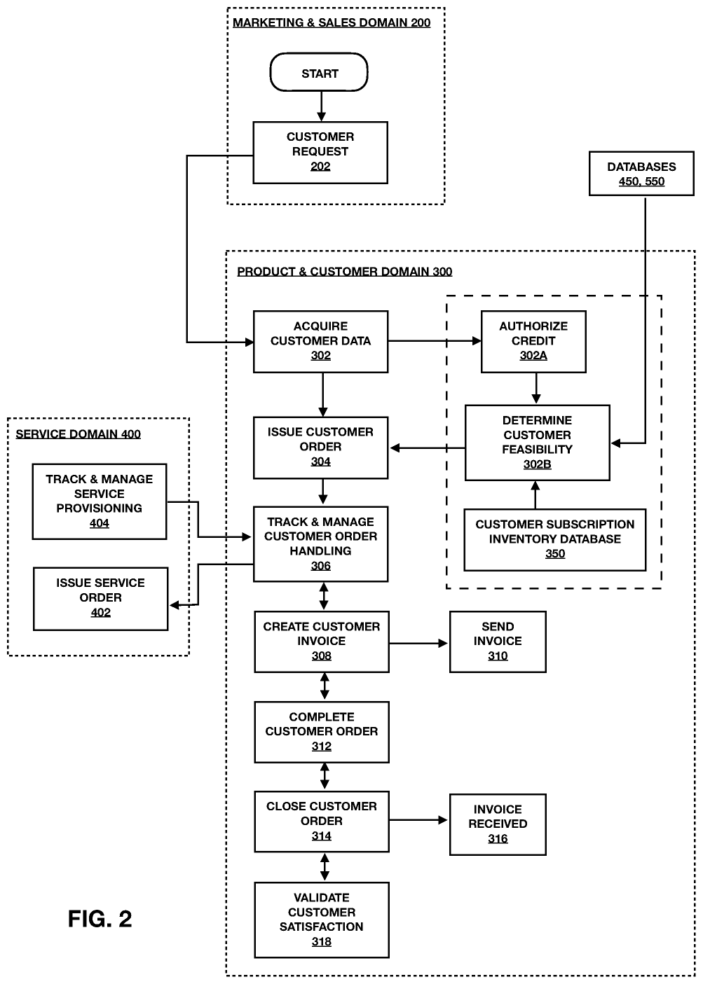

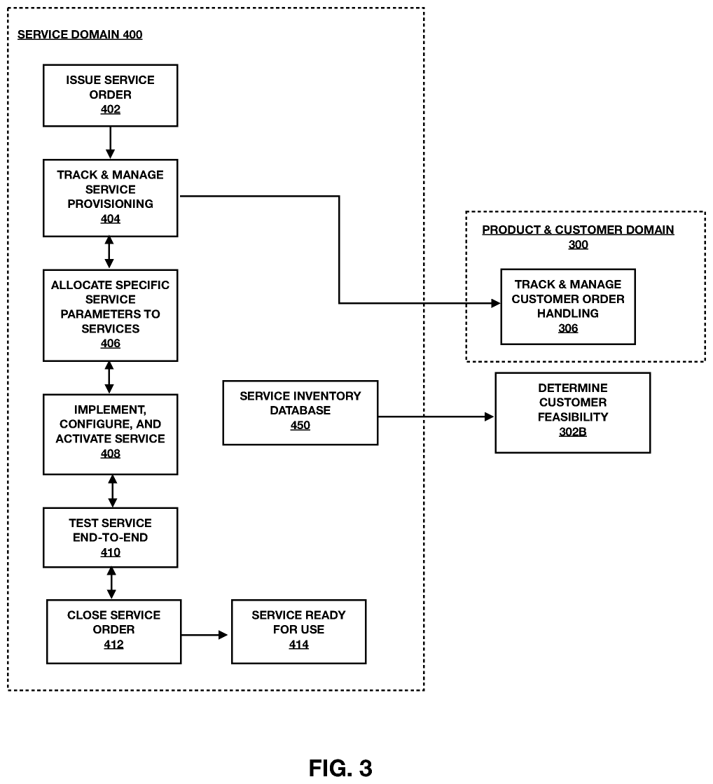

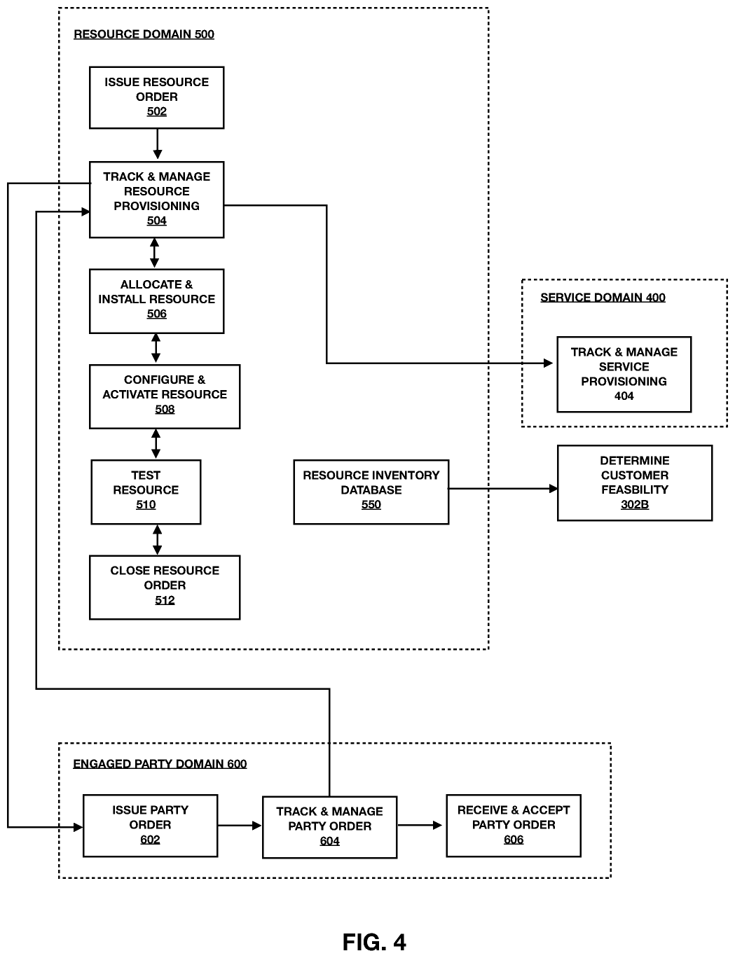

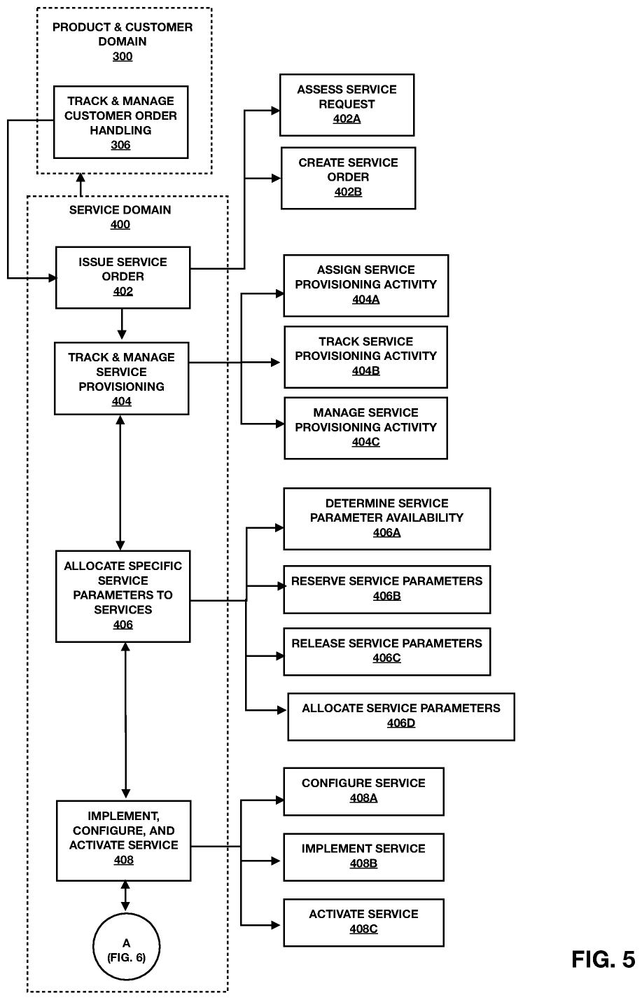

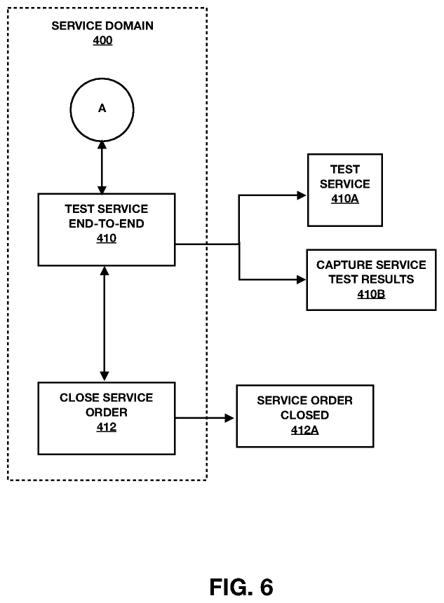

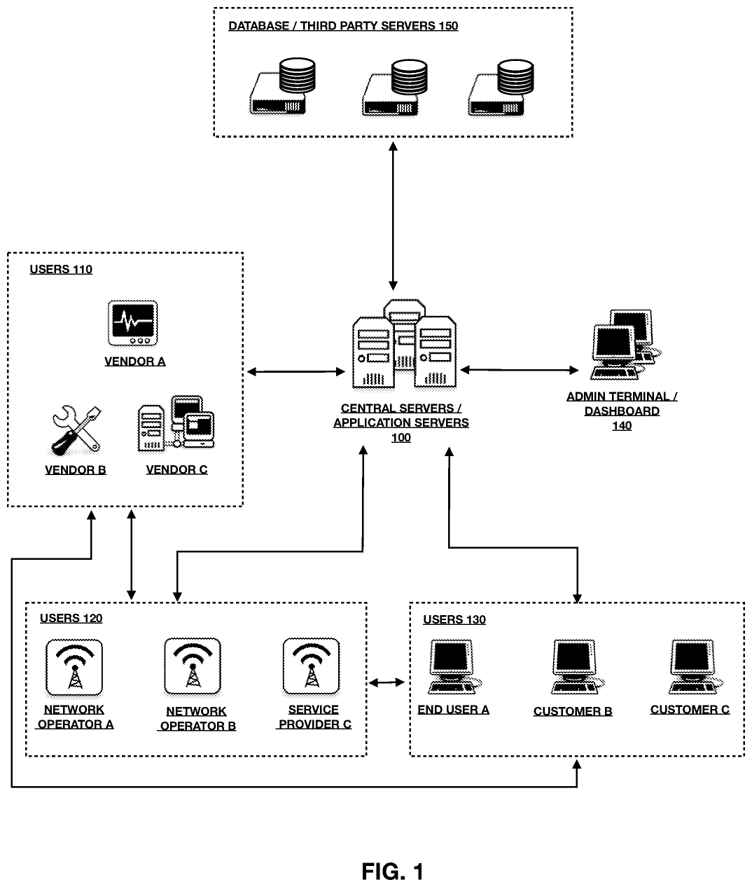

FIG. 1 illustrates a diagram of a general network architecture according to one or more embodiments. Referring to FIG. 1, users 110, 120, and 130 can be in bi-directional communication over a secure network with central servers or application servers 100 according to one or more embodiments. In addition, users 110, 120, 130 may also be in direct bi-directional communication with each other via the centralized platform network system according to one or more embodiments. Here, users 110 can be any type of vendor or service provider, such as vendors A, B, and C offering to either users 120 or users 130 similar, same, or different services or products with respect to a network or service operator. In particular, users 110 can provide any type of telecommunications related service or product, such as cellular service network deployment, network capacity update, operational monitoring, data analytic and reporting, and any other suitable services. Each of users 110 can communicate with servers 100 via their respective terminals or portals. Users 120 can be network operators A and B and service provider C, which may offer similar, same, or different services or products to users 130 or users 110. Here, users 110 or 120 can be any type of telecommunications vendor or network service provider, network operator, carrier, broadband provider, Unified Communications as a Service (UCaaS) providers, wired or wireless cellular network service provider, radio access network (RAN), web host, or any network or telecommunications related service or network provider, among others. Each of users 120 can communicate with servers 100 via their respective terminals or portals. Users 130 can be any type of end user or customer of users 120 or users 110, such as end user A or customers B and C, or the end user purchasing and/or receiving the telecommunications network related services of users 110 or users 120. Each of users 130 can communicate with servers 100 via their respective terminals or portals.

Still referring to FIG. 1, central servers 100 of the centralized platform according to one or more embodiments can be in further bi-directional communication with admin terminal/dashboard 140. Here, admin terminal/dashboard 140 can provide various tools to any of users 110, 120, and 130, or a sales team or a content/product creation team to manage various customers/end users and customer leads, wherein such managing can include, among others, creating, editing, and promoting various types of telecommunications network services or product sales promotional campaigns, advertising, offerings, and ordering options for customers and other users of the centralized platform according to one or more embodiments. In addition, admin terminal/dashboard 140 may also include various types of access privileges to different users of the centralized platform system according to one or more embodiments. Further, central servers 100 according to one or more embodiments can be in further bi-directional communication with database/third party servers 150. Here, servers 150 can provide various types of data storage (such as cloud-based storage), web services, content creation tools, data streams, data feeds, and/or provide various types of third-party support services to central servers 100 of the centralized platform. However, it is contemplated within the scope of the present disclosure described herein that the network services centralized platform process and system according to one or more embodiments can include any type of general network architecture.

Still referring to FIG. 1, one or more of servers or terminals of elements 100-150 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-150 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-150. For example, the bus may be a communication bus, a cross-over bar, a network, or the like. The bus may be implemented using single or multiple (two or more) connections between the set of components of one or more of servers or terminals of elements 100-150. The disclosure is not limited in this regard.

One or more of servers or terminals of elements 100-150 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-150 and/or of the set of components of one or more of servers or terminals of elements 100-150 (e.g., memory, storage component, input component, output component, communication interface, rendering component).

One or more of servers or terminals of elements 100-150 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-150 may store information and/or computer-readable instructions and/or code related to the operation and use of one or more of servers or terminals of elements 100-150. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-150 may further comprise an input component. The input component may include one or more components that permit one or more of servers and terminals 100-150 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-150 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-150 may further comprise a communication interface. The communication interface may include a receiver component, a transmitter component, and/or a transceiver component. The communication interface may enable one or more of servers or terminals of elements 100-150 to establish connections and/or transfer communications with other devices (e.g., a server, another device). The communications may be enabled via a wired connection, a wireless connection, or a combination of wired and wireless connections. The communication interface may permit one or more of servers or terminals of elements 100-150 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

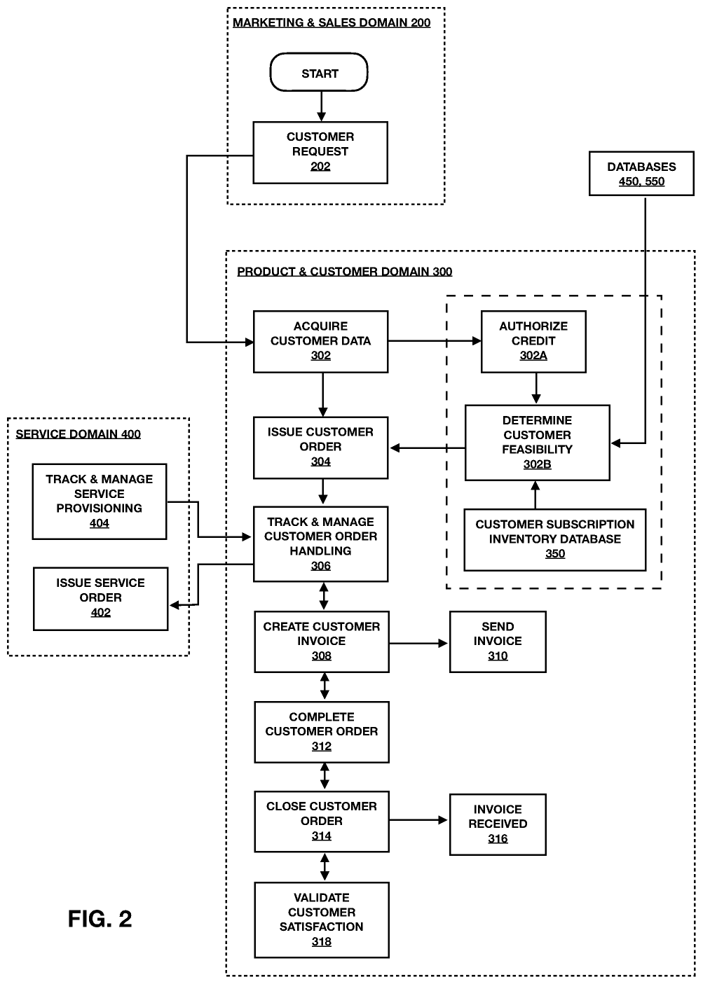

FIGS. 2-6 illustrates various process flows of the centralized platform according to one or more embodiments. In particular, the centralized platform of the disclosure described herein can include a marketing and sales domain 200, product and customer domain 300, service domain 400, resource domain 500, and an engaged party domain 600, wherein each can be in direct or indirect in communication with each other. As used herein, any of domains 200-600 and steps 202-606 of FIGS. 2-6 can also be referred to herein as modules, components, or steps of the centralized platform. As used herein, a customer may also be referred to herein as a user, buyer, service provider, seller, sales team member, or vendor, among others. Referring to FIG. 2, the process can begin at the marketing and sales domain 200, wherein at step 202 a customer request is received to purchase a product or service via the centralized platform of the disclosure described herein (such as a telecommunications related network service). Next, the process can proceed to step 302 of the product and customer domain 300, wherein the customer's data and information is acquired, such as the specific customer order request for one or more products or services, customer information, and customer purchase history, among others. Optionally, at step 302A, the process can also determine if the customer is authorized to purchase (such as via a specific type of payment) and/or receive credit for a purchase. In addition, optionally, at step 302B, the process can determine the feasibility of the customer for ordering a product or service using the centralized platform of the disclosure described herein. Here, the customer feasibility step 302B can make that determination based on receiving data from customer subscription inventory databases 350, service inventory database 450, and resource inventory database 550. Here, such customer feasibility can be based on country or territory specific criteria, such as products or services being made only available for a specific territory or region, among others. Once the customer or the customer's order is determined to be feasible or meets a certain criteria, threshold, or event, then the process can proceed to step 304. It is contemplated within the scope of the present disclosure described herein that the process may also move to step 304 from step 302 without optional steps 302A and 302B.

Still referring to FIG. 2, at step 304, the centralized platform can issue the customer order for the one or more requested or selected products or services. Next, at step 306, the process can track and manage the customer's order and its handling. From here, the process can also issue a service order at step 402 within the service domain 400. In addition, the process can also receive information at step 306 from the track and manage service provisioning step 404 of the service domain 400. Next, the process can proceed to step 308, wherein a customer invoice is created and sent or transmitted to the customer at step 310. At step 312, the customer's order can be completed, such as after receiving and confirming payment from the customer for the selected products or services. Next, at step 314, the process can close a customer's order, such as after completing payment, shipping, scheduling, processing, cancelling, or completing a customer's order request. At step 316, the process can also close an invoice or receiving notification that an invoice was received by the customer. At step 318, the process can send or transmit a survey or request for input to the customer to evaluate the customer's satisfaction with respect to the products, services, or the ordering process, among others.

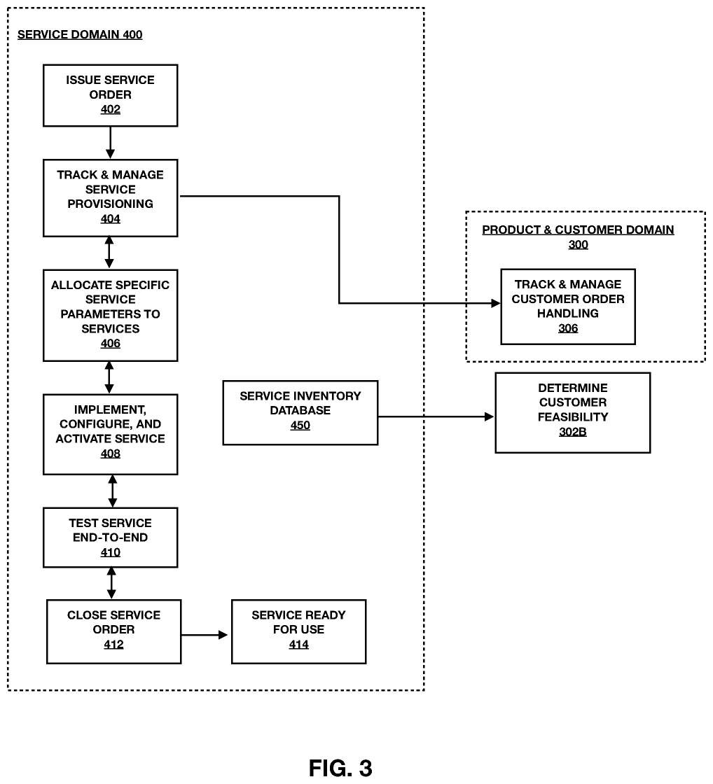

FIG. 3 illustrates a service domain 400 in communication with the product and customer domain 300 of the centralized platform of the disclosure described herein. Here, within the service domain 400, upon receiving the request from the customer with respect to a requested or ordered service (such as the telecommunications related network service or product) or upon completion or closing of the customer's order request at steps 312 and 314, the process can issue a service order at step 402 for the customer's order. Next, at step 404, the process can track and manage the provisioning of the service and proceed to step 406. In addition, at step 404, the process can also move to step 306 by updating the track and manage customer order handling module of the product and customer domain 300, which can be continuous periodic updates as to the provisioning of the service that can be viewed via a dashboard of the centralized platform. Further, the process can also optionally send information from a service inventory database 450 to the customer feasibility step 302B. At step 406, the process can allocate specific service parameters to the issued service order and proceed to step 408. Here, such allocation can pertain to distributing customer specific network resources to a customer based on total available services. For exemplary purposes, if 100 network resources are available, and two are allocated to a customer, then a total of 98 total network resources would remain for future allocation to other customers. Here, such network resources can include but are not limited to servers, routers, switches, file storage, network bandwidth, and download/upload limits, among others.

Still referring to FIG. 3, at step 408, the process can implement, configure, and activate the requested service from the service order, such as remotely (off-site) via the centralized platform of the disclosure described herein or on-site. Such configuring can relate to setting or defining specific settings/parameters for network hardware or software related components or resources, and such activating can relate to placing the foregoing hardware or software related components or resources in an operational, working, or active state. At step 410, the process can test or verify the operation and performance of the implemented, configured, or activated service, such as via remote end-to-end connectivity network testing for that activated service (which can include testing connectivity and performance from one network node to another network node). Further, such end-to-end connectivity testing can also include testing a software application's workflow or a hardware components operation from beginning to end. Upon successful testing, the process can close the service order at step 412, and at step 414, the process can indicate or notify the customer that the service is ready for use and/or is operational.

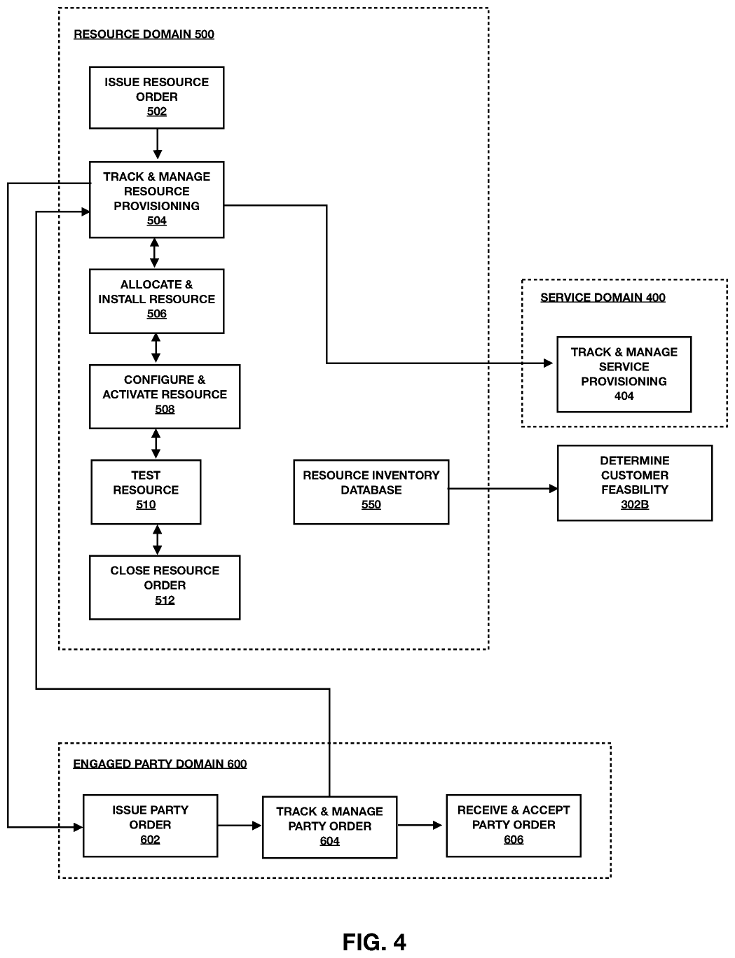

FIG. 4 illustrates a resource domain 500 in communication with the service domain 400 and the engaged party domain 600. Here, within the resource domain 500, upon receiving a request from a customer with respect to a requested resource (such as a telecommunications related resource), the process can issue a resource order at step 502 for the customer. Next, at step 504, the process can track and manage the provisioning of the resource and proceed to step 406. In addition, at step 504, the process can also move to step 404 by updating the track and manage customer order handling module of the service domain 400. Further, the process can also optionally send information from a resource inventory database 550 to the customer feasibility step 302B. At step 506, the process can automatically allocate and install the requested resource and proceed to step 508. At step 508, the process can implement, configure, and activate the requested resource from the issued resource order, such as remotely (off-site) via the centralized platform of the disclosure described herein or on-site. At step 510, the process can test or verify the operation of the implemented, configured, or activated resource, such as via remote end-to-end testing. Upon successful testing, the process can close the resource order at step 512, and the process can further indicate or notify the customer that the resource is ready for use and/or is operational.

Still referring to FIG. 4, within the engaged party domain 600 the process can issue an order for a party at step 602 which can be received from the track and manage resource provisioning step 504 of resource domain 500 and proceed to step 604. As previously discussed herein, a party can be any third party, such as for installing or implementing the ordered service. At step 604, the process can track and manage the handling of the party's order and further send an update to the track and manage resource provisioning step 504 of resource domain 500. Next, at step 606, the process can receive and accept the party's order.

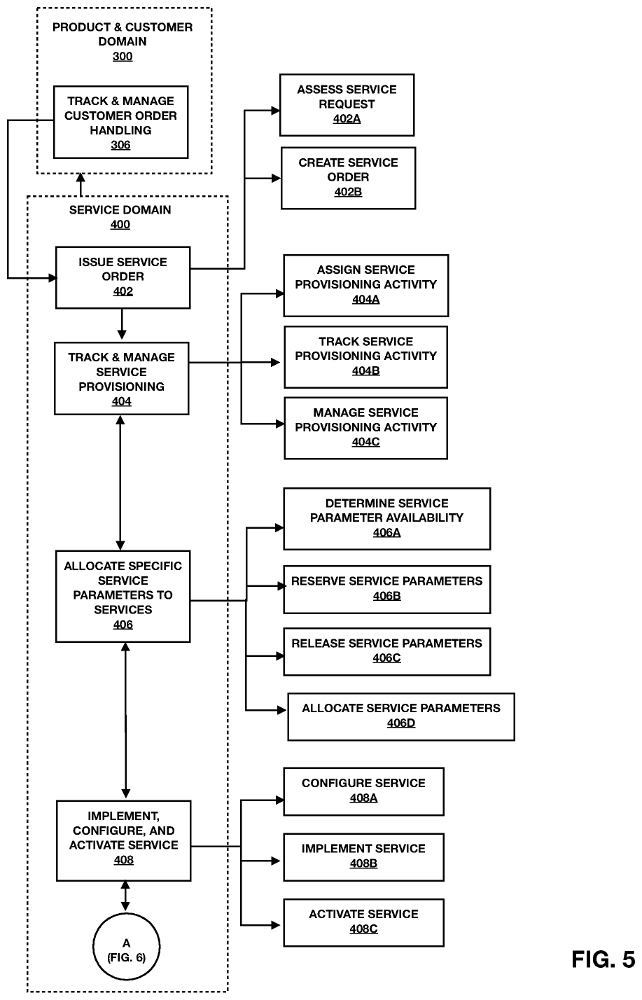

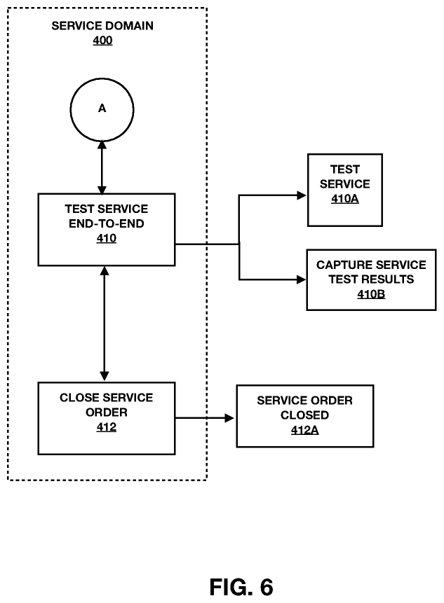

FIG. 5 illustrates a more detailed flowchart of FIG. 3, further illustrating additional steps and modules with respect to the service domain 400, which can also be referred to as a service activation and configuration module. Here, after the track and manage customer order handling step 306 of the product and customer domain 300, which can also be referred to as a customer order orchestration module, the process can move step 402. At step 402 of the service domain 400, the process can issue the service order, which can further include assessing or evaluating the service request at 402A, and upon successful evaluation (such as for feasibility or implementation), then creating the service order at step 402B. Next, at the track and manage service provisioning step 404, the process can further include assigning the service with provisioning activity at step 404A, tracking the service provisioning activity at step 404B, and managing the service provisioning activity at step 404C. Next, at the allocate specific parameters to services step 406, the process can further include determining one or more service parameter availability at step 406A, and if one or more service parameters are available, then reserving the one or more service parameters at step 406B, releasing the one or more service parameters 407B (such as when a customer cancels or downgrades a service order), and then allocating the one or more service parameters at step 406D. Here, service parameters can include available network or shared resources, such as servers, routers, switches, file storage, network bandwidth, and download/upload limits, among others. Next, at the implement, configure, and activate service step 408, the process can further include configuring the service at step 408A, implementing the service at step 408B, and activating the service for the customer at step 408C. Next, the process can move to step A, which is continued on FIG. 6. Referring to FIG. 6, at the test service end-to-end step 410 (which a continuation of step 408), the process can further include testing the service at 410A, and capturing and saving the test results at step 410B. Next, at the close order step 412, the process can further close the customer's service order at step 412A.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A computer-implemented method of ordering elecommunications related services via a centralized platform, the method comprising:
receiving a first service order request from a user to purchase a telecommunications related service;
allocating one or more service parameters with respect to first service order;
implementing the telecommunications related service for the user with respect to the received first service order request; and
verifying the implementation of the telecommunications related service.

2. The method of claim 1, wherein the step of receiving the first service order request further comprises determining a viability or feasibility of the first service order request, and upon determining that first service order request is viable or feasible, creating a second service order with respect to the first service order request.

3. The method of claim 1, wherein the step of implementing the telecommunications related service with respect to the first service order request further comprises configuring and activating the telecommunications related service.

4. The method of claim 1, wherein the step of verifying the implementation of the telecommunications related service further comprising testing an end-to-end connectivity and performance of the telecommunications related service.

5. The method of claim 1, wherein the step of allocating one or more service parameters with respect to the first service order further comprises determining an availability of the one or more service parameters with respect to the first service order request.

6. The method of claim 5, further comprising:
upon determining that the telecommunications related service is available, reserving the one or more service parameters with respect to the telecommunications related service;
tracking the allocation, implementation, or verification of the telecommunications related service; and
closing the first service order request.

7. The method of claim 1, wherein the step of verifying the implementation of the telecommunications related service further comprises storing the results of the verification.

8. The method of claim 1, further comprising:
initiating a first resource order with respect to the first service order request; and
allocating one or more resources with respect to the first resource order.

9. The method of claim 8, further comprising:
activating the allocated one or more resources with respect to the first resource order.

10. The method of claim 9, further comprising:
verifying the activated one or more resources with respect to first resource order.

11. An apparatus for ordering telecommunications related services via a centralized platform, comprising:
a memory storage storing computer-executable instructions; and
a processor communicatively coupled to the memory storage, wherein the processor is configured to execute the computer-executable instructions and cause the apparatus to:
receive a first service order request from a user to purchase a telecommunications related service;
allocate one or more service parameters with respect to first service order;
implement the telecommunications related service for the user with respect to the received first service order request; and
verify the implementation of the telecommunications related service.

12. The apparatus of claim 11, wherein the computer-executable instructions, when executed by the processor, further cause the apparatus to:
wherein the step of receiving the first service order request further cause the apparatus to determine a viability or feasibility of the first service order request, and upon determining that the first service order request is viable or feasible, create a second service order with respect to the first service order request.

13. The apparatus of claim 11, wherein the computer-executable instructions, when executed by the processor, further cause the apparatus to:
wherein the step of implementing the telecommunications related service with respect to the first service order request further cause the apparatus to configure and activate the telecommunications related service.

14. The apparatus of claim 11, wherein the computer-executable instructions, when executed by the processor, further cause the apparatus to:
wherein the step of verifying the implementation of the telecommunications related service further cause the apparatus to test an end-to-end connectivity and performance of the telecommunications related service.

15. The apparatus of claim 11, wherein the computer-executable instructions, when executed by the processor, further cause the apparatus to:
wherein the step of allocating one or more service parameters with respect to the first service order further cause the apparatus to determine an availability of the one or more service parameters with respect to the first service order request.

16. The method of claim 15, wherein the computer-executable instructions, when executed by the processor, further cause the apparatus to:
upon determining that the telecommunications related service is available, reserve the one or more service parameters with respect to the telecommunications related service;
track the allocation, implementation, or verification of the telecommunications related service; and
close the first service order request.

17. The apparatus of claim 11, wherein the computer-executable instructions, when executed by the processor, further cause the apparatus to:
wherein the step of verifying the implementation of the telecommunications related service further cause the apparatus to store the results of the verification.

18. The apparatus of claim 11, wherein the computer-executable instructions, when executed by the processor, further cause the apparatus to:
initiate a first resource order with respect to the first service order request; and
allocate one or more resources with respect to the first resource order.

19. The apparatus of claim 18, wherein the computer-executable instructions, when executed by the processor, further cause the apparatus to:
activate the allocated one or more resources with respect to the first resource order.

20. A non-transitory computer-readable medium comprising computer-executable instructions for ordering telecommunications related services via a centralized platform by an apparatus, wherein the computer-executable instructions, when executed by at least one processor of the apparatus, cause the apparatus to:
receive a first service order request from a user to purchase a telecommunications related service;
allocate one or more service parameters with respect to first service order;
implement the telecommunications related service for the user with respect to the received first service order request; and
verify the implementation of the telecommunications related service.
